(19) United States
(12) Patent Application Publication
(10) Pub. No.: US 2008/0106367 A1
(43) Pub. Date: May 8, 2008

(54) CROSS CONDUCTION PROTECTION ON ANTENNAS

(75) Inventors: Patricia Kachouh, Sterling Heights, MI (US); Brian Marlett, Macomb, MI (US); Gerald Ostrander, Davison, MI (US); Tejas B. Desai, Troy, MI (US); Scott Lucy, Lake Orion, MI (US); Brian Saloka, Roseville, MI (US)

Correspondence Address: SIEMENS CORPORATION;INTELLECTUAL PROPERTY LAW DEPARTMENT, 170 WOOD AVENUE SOUTH, attn: SV-CONTI TRANSITION, ISELIN, NJ, 08830, US

(73) Assignee: SIEMENS VDO AUTOMOTIVE CORPORATION, Auburn Hills, MI (US)

(21) Appl. No.: 11/934,905

(22) Filed: Nov. 5, 2007

Related U.S. Application Data
(60) Provisional application No. 60/856,688, filed on Nov. 3, 2006.

(51) Int. Cl. B60R 25/00; H04B 7/005

(52) U.S. Cl. 340/5.2; 455/41.2

(57) ABSTRACT

A passive entry and start system transmits a neutral signal over all the antennas except for that antenna that is proximate an area in which transmission to an identification device is desired. Accordingly, the area of a vehicle and those physical features that are proximate and associated with the area is isolated to prevent undesired operation of other vehicle mechanisms.

### CROSS REFERENCE TO RELATED APPLICATION

The application claims priority to U.S. Provisional Application No. 60/856,688 which was filed on Nov. 3, 2006.

### BACKGROUND OF THE INVENTION

This invention generally relates to a passive start and entry system for a vehicle. More particularly, this invention relates to a passive start and entry system that includes features for localizing the active range of an identification device.

A passive start and entry system includes several antennas for transmitting a challenge signal to an identification device. Undesirably, the close proximity of each of the antennas and corresponding wires and connectors within the vehicle can cause a cross coupling problem that can cause generation of a weak signal that is undesirably transmitted from other antennas that do not correspond to an intended location of the vehicle. For example, a challenge signal to an antenna intended to illicit a response from an identification device proximate a driver's side door can cause the generation of a weak challenge signal in other antennas in other locations of the vehicle due to the close proximity of wires or connections at the control module. Accordingly, other identification devices that are not in a desired area may receive challenge transmissions from the vehicle control module. Such an occurrence could allow undesired access to vehicle functions.

Accordingly, it is desirable to design and develop a system and method for preventing undesired transmissions from selected antennas within a vehicle.

### SUMMARY OF THE INVENTION

A passive start and entry system includes a controller that transmits challenge signals over a plurality of antennas. The controller transmits a neutral signal over each of the antennas except for a selected antenna in which a challenge transmission to an identification device is desired.

The example controller transmits a neutral signal over each of the plurality of antennas except for one of the antennas which is associated with an area in which a transmission to the identification device is desired. This prevents the cross conduction and incorrect transmission of signals to identification devices that are not in a desired area. The positive transmission of the neutral signal provided by the controller to all but the selected antenna prevents the undesired transmission from other antennas caused by cross coupling between proximate wires within the vehicle.

Accordingly, the example passive entry and operation system prevents undesired transmission over non-selected antennas.

These and other features of the present invention can be best understood from the following specification and drawings, the following of which is a brief description.

### BRIEF DESCRIPTION OF THE DRAWINGS

FIG. 1 is a schematic representation of this system.

FIG. 2 is an example schematic of system operation with an identification device in a first area.

FIG. 3 is another example schematic representation of system operation with the identification device in a second area.

### DETAILED DESCRIPTION OF THE PREFERRED EMBODIMENT

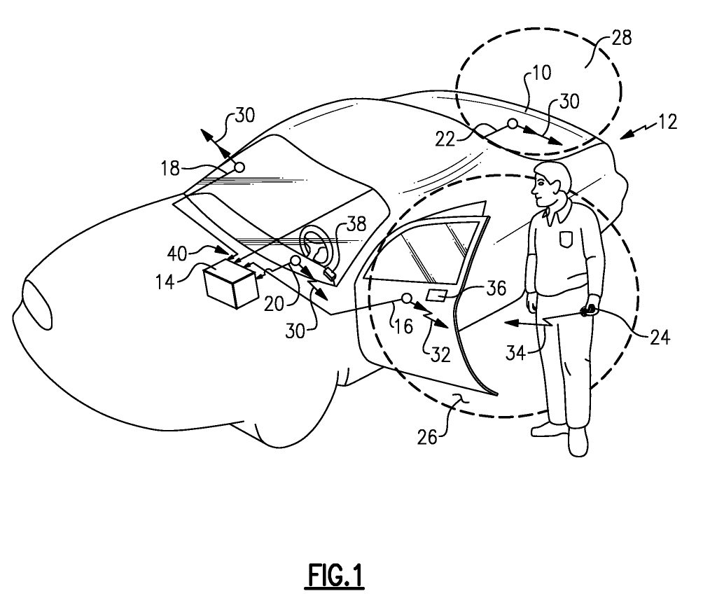

Referring to FIG. 1, the example system 12 includes a controller 14, disposed within a vehicle 10. The controller 14 controls transmissions from a plurality of antennas 16, 18, 20, 22. Each of the antennas is utilized to transmit a low frequency challenge signal to prompt a return response from an identification device 24 disposed within an area associated with a portion of the vehicle 10.

The controller 14 sends a challenge signal 32 through one of the plurality of antennas 16, 18, 20, 22 to prompt a response from any identification device 24 within that area. It is desired that the transmission be localized to a desired area and not prompt responses from identification devices associated with the other areas of the vehicle.

The controller 14 sends out a neutral signal 30 from all of the plurality of antennas except the antenna that is within the area in which actuation of vehicle functions is desired. In the disclosed example the antenna 16 is associated with the first area 26 in which the challenge transmission 32 to a proximate identification device 24 is desired. A neutral signal 30 is transmitted over the other remaining antenna 18, 20, 22 that does not prompt a response from any identification device including the identification device disposed within the first area 26.

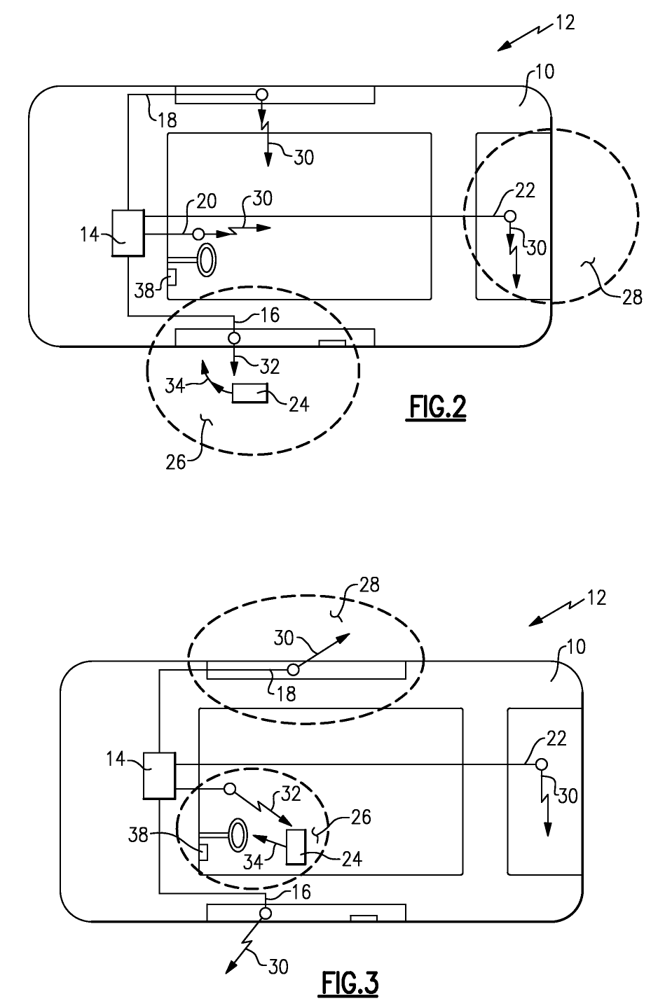

Referring to FIG. 2, a schematic illustration shows the first area 26 and a second area 28. In operation it is desired that only those physical features of the vehicle 10 that are proximate the identification device 24 be operable in response to the proximate location of that identification device 24. Accordingly, the controller 14 upon sensing of a physical actuation such as pulling on a door handle 36 or other physical prompt will isolate transmission of viable low frequency challenge signals 32 to that specific area. In the example, the first area 26 is proximate to the door handle 36. Upon actuation of the door handle 36, the controller 14 transmits neutral signals 30 to each of the plurality of antennas that are not proximate the first area 26. The first antenna 16 transmits the low frequency challenge signal 32. Accordingly, any identification devices that are proximate the other antennas 18, 20, 22 will not receive a transmission that will prompt any kind of reply. By localizing the challenge signal to a signal antenna and positively transmitting a neutral signal 30 to the other antennas, cross conduction of the desired transmission signal 34 to any other of the plurality of antennas 18, 20, 22 is not permitted.

In this example, it is desired only to allow a user to operate the door handle 36 that is proximate the first area 26. Prompt for transmission of the challenge signal 32 is provided by the physical actuation of the door handle 36. Upon sensing and verification of this physical prompt, the controller 14 initiates the challenge transmission 32 through the first antenna 16 to the identification devices 24 proximate the first area 26. The neutral signal 30 is transmitted by all the other antennas 18, 20, 22 and does not prompt a response from any identification devices in other areas of the vehicle.

Referring to FIG. 3, as the user and identification device 24 moves around the vehicle 10 and actuates different physical prompts, the area in which transmission of prompt signals is desired to cause a response from the identification device also changes. The area 26 in which the prompt signal to the identification device 24 is desired has moved into the vehicle and the physical prompt can be for example actuation of an ignition switch 28. The transmission of prompt signals from the controller 14 to one of the antennas 16, 18, 20, and 22 can overlap various other antennas by way of the wiring harness 40 that extends from the controller 14 to the various areas of the vehicle 10. Because the other antennas 16, 18, 22 are transmitting the neutral signal 30 that does not prompt a response from the identification device 24, no signals will be prompted from identification devices proximate the other antennas. Accordingly, the area in which the transmission is sent to prompt a response signal 34 from the identification device 24 is substantially isolated to prevent undesired access to other portions and areas of the vehicle 10.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of limiting an active range of an identification device for a vehicle passive start and entry system comprising the steps of:
a) determining an area within which a prompt signal to a remote identification device is desired; and
b) sending a neutral signal to prevent transmission of the prompt signal from another antenna corresponding to an area other than the desired area.

2. The method as recited in claim 1, wherein the step of determining an area within which a prompt signal to a remote identification device is desired includes the step of physically prompting actuation of a portion of a vehicle.

3. The method as recited in claim 2, wherein the physically prompting actuation step is associated with a device proximate a first of a plurality of antennas and said step b) includes sending the neutral signal to others of the plurality of antenna's not associated with the first of the plurality of antennas.

4. The method as recited in claim 1, including the step of transmitting a challenge signal to prompt a response signal from a remote identification device within the desired area.

5. The method as recited in claim 1, wherein the neutral signal does not illicit a response from a remote identification device.

6. The method as recited in claim 1, wherein a desired area is associated with one of a plurality of antennas and the neutral signal is transmitted from others of the plurality of antennas not associated with the desired area.

7. The method as recited in claim 6, wherein the desired area is defined as a portion of a motor vehicle.

8. A passive start and entry system for a motor vehicle comprising:
a controller; and
a plurality of antennas for transmitting a challenge signal from the controller, wherein each of the plurality of antennas is associated with a corresponding area of the vehicle and the control module sends transmissions over each of the plurality of antennas to select which of the plurality of antennas transmits a challenge signal to a remote identification device.

9. The system as recited in claim 8, including an area of the motor vehicle associated with each of the plurality of antennas.

10. The system as recited in claim 8, wherein the controller operates to send a neutral signal over all of the plurality of antennas except for a selected one of the plurality of antennas proximate an area of the motor vehicle from which a response is desired.

11. The system as recited in claim 10, wherein the neutral signal comprises a signal that does not illicit a response from an identification device.

12. The system as recited in claim 10, wherein the system operates to prevent transmission of challenge signals to areas associated with all of the plurality of antennas except an area associated with the selected one of the plurality of antennas.

13. The system as recited in claim 8, including an authentication device receiving a challenge signal from a selected one of the plurality of antennas.

14. The system as recited in claim 13, wherein the authentication device responds only to transmissions emitted from the selected one of the plurality of antennas.
